(19) United States
(12) Patent Application Publication
(10) Pub. No.: US 2005/0108117 A1
(43) Pub. Date: May 19, 2005

(54) Method and apparatus for providing itemization detail for credit card transactions

(76) Inventor: Warrren Newman, Inez, TX (US)

Correspondence Address: WILLIAMS, MORGAN & AMERSON, P.C., 10333 RICHMOND, SUITE 1100, HOUSTON, TX, 77042, US

(21) Appl. No.: 10/717,124

(22) Filed: Nov. 19, 2003

(51) Int. Cl. G06F 17/60

(52) U.S. Cl. 705/30; 705/39

(57) ABSTRACT

A method for processing transactions includes initiating a transaction to access an account. An authorization request is sent to an authorization entity associated with the account. Itemization detail data associated with the transaction is sent to the authorization entity. At least the itemization detail data is routed to an owner of the account. A system for processing transactions includes a vendor entity and an authorization entity. The vendor entity is adapted to initiate a transaction to access an account, generate an authorization request, and generate itemization detail data associated with the transaction. The authorization entity is associated with the account and adapted to the receive authorization request, receive the itemization detail data from the vendor entity, and route at least the itemization detail data to an owner of the account.

### BACKGROUND OF THE INVENTION

1. Field of the Invention

This invention relates generally to the field of electronic commerce and, more particularly, to a method and apparatus for providing itemization detail for credit card transactions.

2. Description of the Related Art

Many business and personal transactions are conducted using credit or debit transactions linked to an account at a bank or other financial institution. Many companies provide employees with company credit cards for the purpose of paying for business expenses and purchases. Similarly, individuals sometimes have additional credits cards linked to their account that they provide to family members for making purchases. Debit and credits cards may also be used for cash advances from a credit account or withdrawals from a bank account.

Typically, when a holder of a transaction card (e.g., credit or debit card) presents the card to a vendor, the vendor scans the magnetic strip of the card and transmits data encoded thereon (i.e., identification data) along with data associated with the transaction (i.e., transaction summary data) to an issuer of the card or central network tasked with verifying transaction for the card issuer, otherwise referred to an as authorization entity. Based on the identification and transaction summary data, the authorization entity approves or denies the transaction depending on limitations associated with the account (e.g., account balance, spending limit, daily withdrawal limit, etc.). If the transaction is approved, the authorization entity stores the transaction summary data (e.g., date/time, vendor identification data, amount), posts the transaction to the card owner's account, and returns an authorization code to the vendor indicating acceptance of the transaction. The vendor typically provides the card user with an itemized receipt and a credit card receipt indicating the transaction summary data.

Because, the account owner authorizes other individuals to use the account (e.g., employees in a business context or family members in a family context), the account owner typically has some degree of trust in the authorized users that they will not improperly access the account by exceeding the credit limit, using the account for unauthorized purchases, etc. However, it is still possible that the authorized user may abuse the privileges granted by the account owner. For example, an employee may purchase personal items using a company account or a family member may make excessive purchases. Ultimately, the account owner would be responsible for the purchases whether or not they were within the scope of the privileges intended to be granted to the authorized user.

One technique an account holder may employ to attempt to identify account abuses is to monitor transactions posted to the account. Typically, credit card and bank institutions allow owners to access their accounts online over the Internet. However, the account information provided only represents the transaction summary data that identifies the amount of the transaction, the posting date, and the vendor. This information does not allow the owner to monitor the particular details of the purchase to determine if unauthorized purchases are being made. Also, there is typically a delay of one or more days between the time the transaction occurs and the summary information is available for the account owner to view.

Another issue associated with accounts accessible by multiple individuals lies in the financial accounting for the transactions. Typically, a business may be able to deduct or capitalize expenses charged to the account. However, to adequately document the expenses, an itemized receipt is often required by the Internal Revenue Service. Hence, the itemized receipt and not the credit card receipt is required to document the expenses. It is not uncommon for the account user to misplace either the itemized receipt or the credit card receipt. Although the information on the credit card receipt is often available from the card issuer (i.e., via the Internet or account statements), the itemized data cannot be readily recreated. In such cases, the business may not be able to deduct the expenses.

The present invention is directed to overcoming, or at least reducing the effects of, one or more of the problems set forth above.

### SUMMARY OF THE INVENTION

One aspect of the present invention is seen in a method for processing transactions. A transaction to access an account is initiated. An authorization request is sent to an authorization entity associated with the account. Itemization detail data associated with the transaction is sent to the authorization entity. At least the itemization detail data is routed to an owner of the account.

Another aspect of the present invention is seen in a system for processing transactions including a vendor entity and an authorization entity. The vendor entity is adapted to initiate a transaction to access an account, generate an authorization request, and generate itemization detail data associated with the transaction. The authorization entity is associated with the account and adapted to the receive authorization request, receive the itemization detail data from the vendor entity, and route at least the itemization detail data to an owner of the account.

### BRIEF DESCRIPTION OF THE DRAWINGS

The invention may be understood by reference to the following description taken in conjunction with the accompanying drawings, in which like reference numerals identify like elements, and in which:

FIG. 1 is a simplified block diagram of a communication system for processing transactions in accordance with the one illustrative embodiment of the present invention;

FIG. 2 is a diagram of an exemplary transaction detail report routed by the system of FIG. 1; and

FIG. 3 is a simplified flow diagram of a method for processing transactions in accordance with another illustrative embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

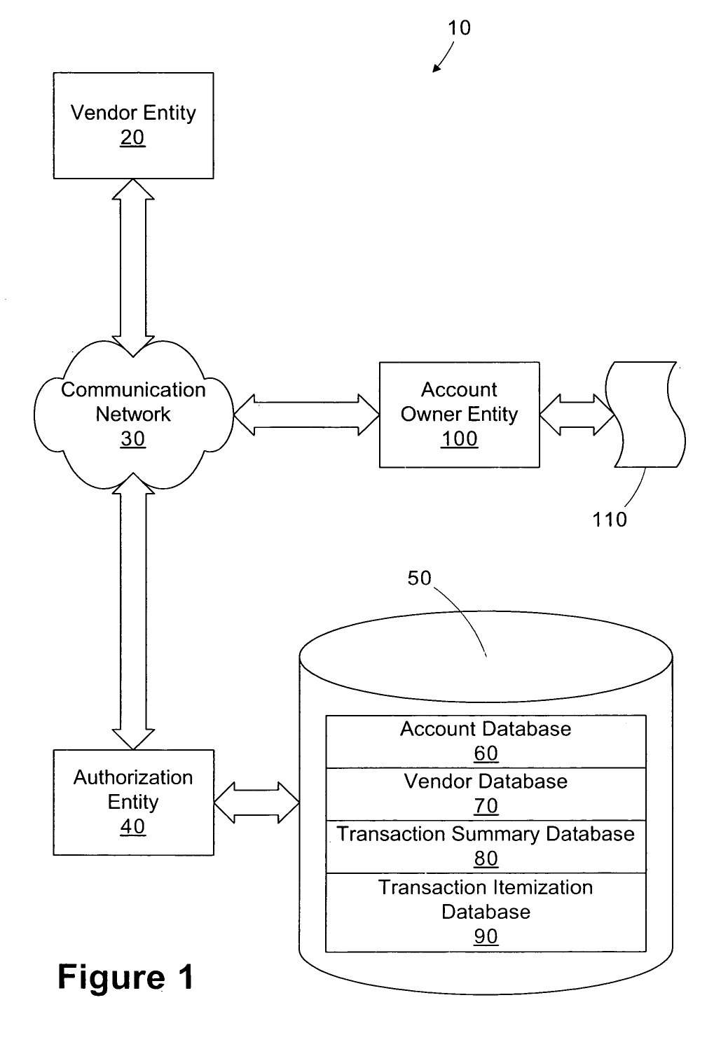

Referring to FIG. 1, a simplified block diagram of a communication system 10 for processing transactions in accordance with the one illustrative embodiment of the present invention is provided. In general, the communication system 10 provides an account owner with itemization data related to the transactions posted to the account. The particular type of account or technique for accessing the account may vary. For example, the account may be a credit account, a banking account (e.g., saving or checking), or some other type of account to which transactions may be posted. An account user may access the account using a variety of techniques, including, but not limited to, a credit card, debit card, device encoded with account information (e.g., handheld computer, keychain), computer communicating with the vendor, etc. The account may also be accessible without a physical component, such as through an online, telephone, or other type of transaction, where a card is not used.

The communication system 10 includes a vendor entity 20 where a transaction is initiated by an account user. The vendor entity 10 may have a variety of implementations, such as a card scanner, a register, a computer terminal, etc. The vendor entity 20 sends a transaction approval request over a communication network 30 to an authorization entity 40. The transaction approval request includes information such as the account and user information read from the transaction card, or other physical or non-physical implementation, vendor identification information, and transaction summary information, such as the date, time, total amount of purchase, etc. The particular data included in the transaction approval request may vary depending on the particular embodiment and the requirements of the vendor or authorization entity, and the application of the present invention is not limited to the particular data used for illustrative purposes herein.

The communication network 30 may have a variety of implementations, including but not limited to, a publicly switch telephone network (PSTN), a local (LAN) or wide area network (WAN), a wireless connection, a satellite connection, etc. The authorization entity 40 may be operated by the financial institution that provides the owner's account, or by another entity operating for the financial institution to approve or reject transaction requests.

The authorization entity 40 maintains a data store 50 including an account database 60 for storing data related to valid accounts maintained by the financial institution, a vendor database 70 storing data related to authorized vendors, a transaction summary database 80 for storing the summary information related to the transaction, and a transaction itemization database 90 for storing itemized details of the transactions.

Of course, more than one data store 50 may be employed, and such data stores may be centrally located or remotely distributed. Also, the databases employed may be arranged differently, or may include more or less information than the illustrative embodiment described herein, depending on the particular implementation. For instance, the transaction summary and detail databases 80, 90 may be merged into a single database.

In general, the vendor entity 20 provides itemization detail information associated with the transaction to the authorization entity 40 upon acceptance of the transaction, and the authorization entity 40 forwards at least the transaction itemization data to an account owner entity 100. The authorization entity 40 may employ conventional techniques for approving transaction requests, such as verifying the account number and user data, checking a credit limit or usage restriction on the account, etc. The account owner may then receive a transaction detail report 110 based on the received itemization data. The transaction detail report 110 may combine the transaction itemization data with the transaction summary data, for example. The account owner may then use the transaction detail report 110 for oversight or accounting purposes. Because the transaction detail report 110 includes the detailed itemization data it may be sufficient documentation for tax accounting purposes.

Although the authorization entity 40 is illustrated as authorizing the transaction and forwarding the transaction detail report 110 to the account owner, it is contemplated that a separate entity may be used. For example, one entity may perform the authorization function, and another entity may perform the routing function. These entities need not even be performed by the same business unit or company.

The transaction itemization data may take on a variety of forms. In one embodiment, the transaction itemization data may be a text based file that includes item descriptions for the items purchased and the price paid for each item. Additional data may be provided for a merchandise total, sales tax, and an overall total. Identification data, such as the name of the account user in text form, may also be provided. In the case where multiple users are authorized to use the account, the identification data aids the account owner in determining which users are associated with which transactions.

In another embodiment, the transaction itemization data may include graphic data representing a “carbon copy” of the receipt provided by the vendor, including the itemization details and the signature of the account user. To generate the graphic data, the vendor entity 20 may have a scanning device (not shown) attached or integrated with the device used to communicate with the authorization entity 40. After processing the transaction, the vendor may scan the signed receipt and transmit the receipt to the authorization entity 40.

It is also contemplated that the transaction itemization data may include a combination of text data and graphic data. For instance, the line item details, tax, and totals may be stored using text data and the signature may be stored using an image file. Certain register systems used by vendors electronically capture the account user's signature as it is signed on a touch screen. This captured data may be combined with the data records associated with the transaction for the items purchased.

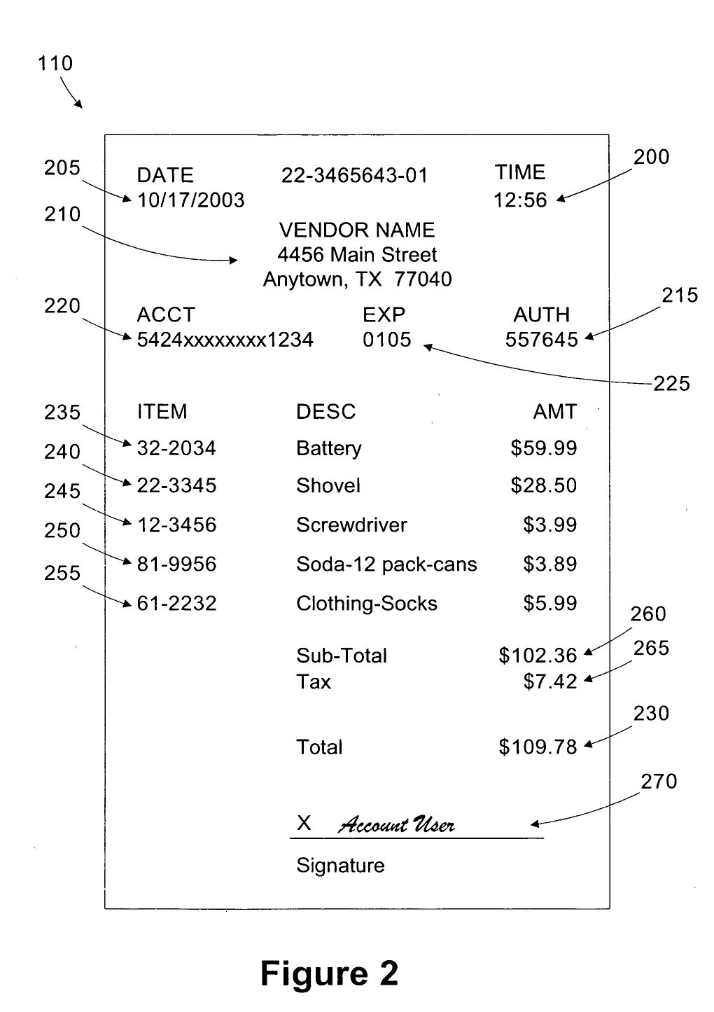

An exemplary transaction detail report 110 is illustrated in FIG. 2. In one example the account owner may authorize transactions, such as fuel, tires, batteries, shovels, certain tools, office supplies, motel charges, etc. However, other purchases, such as personal items, clothing, soft drinks, alcoholic beverages, hunting and fishing supplies, fuel on Sundays, fuel outside of working area.

The transaction detail report 110 includes summary data such as time data 200, date 205, vendor data 210, authorization code data 215, account number data 220, expiration date data 225, and transaction total data 230. Itemization detail data 225 included on the transaction detail report 110 includes line items 235, 240, 245, 250, 255 that each specify an item number, an item description, and an item price. Data may also be provided for a sub-total 260 and sales tax 265. Signature data 270 may also be provided indicating the name of the account user that completed the transaction.

By examining the transaction detail report 110, the account owner is able to determine that the account user may have made unauthorized purchases for soda in line item 250 and clothing in line item 255. If the account user had only turned in a receipt including the summary data, this unauthorized usage may have gone undetected.

The transaction detail report 110 may be communicated using a variety of techniques. In one embodiment, the authorization entity 40 may send the transaction detail report 110 to the account order immediately upon, or shortly after, posting the transaction to the account owner's account. The authorization entity 40 may communicate the transaction detail report 110 using a facsimile connection to the owner, a modem connection to the owner, a network connection to the owner, etc. The authorization entity 40 may also provide the transaction detail report 110 over a web interface with the owner (i.e., via an Internet connection). The authorization entity 40 may also send an email to the account owner for every transaction. In some embodiments, the owner may have to initiate a connection with the financial institution over the communication network 30 periodically to retrieve recent transactions and associated transaction detail reports 110. In yet another embodiment, the routing information may be encoded on the account card (e.g., a fax number or email address), and the vendor entity 20 may route the transaction detail report 110 directly to the owner responsive to receiving approval for the transaction.

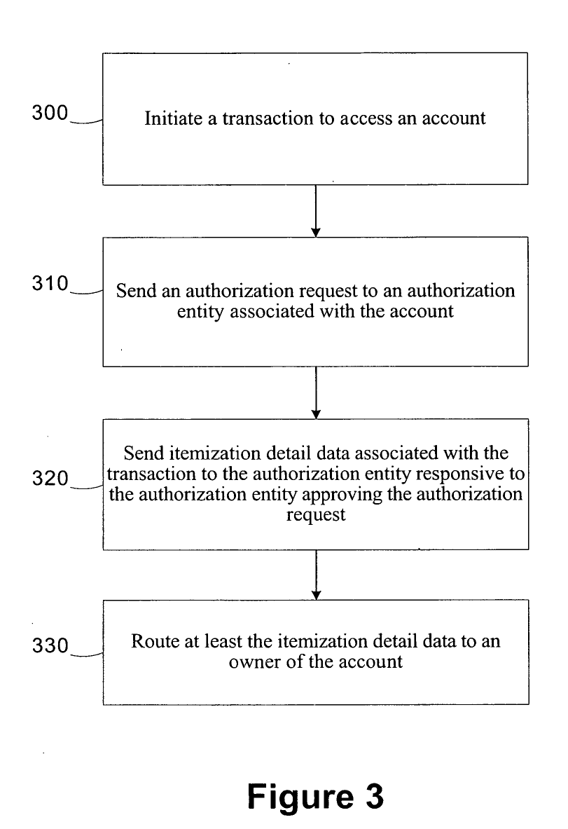

Turning now to FIG. 3, a simplified flow diagram of a method for processing transactions in accordance with another illustrative embodiment of the present invention is provided. In block 300, a transaction to access an account is initiated. For example, an account user presents a vendor 20 with a transaction card or account number for purchasing goods or services. In block 310, an authorization request is sent to an authorization entity 40 associated with the account. Typically, the authorization request includes transaction summary data and identification data associated with the user and the account to be accessed. In block 320, itemization detail data associated with the transaction is sent to the authorization entity 40 responsive to the authorization entity 40 approving the authorization request. The authorization entity 40 may approve the transaction by comparing the identification data to account data in the account database 60 and comparing the identity of the vendor to records in the vendor database 70. Upon approval, the authorization entity 40 may then store the transaction summary information in the transaction summary database 80. Approval may also be based on credit limits or usage restrictions associated with the account. In block 330, the itemization detail is routed to an owner of the account. The vendor entity 20 or the authorization entity 40 may route the itemization detail data. If the authorization agent 40 routes the itemization detail data, it may store the itemization detail data in the transaction itemization database 90. The authorization agent 40 may delete the itemization detail data from the transaction itemization database 90 after delivery to the account owner.

Providing the account owner with transaction itemization detail data has numerous advantages. The owner may monitor transactions charged to account to ensure that they are proper. The account owner may also use the transaction itemization detail for accounting or tax purposes in the event the original transaction record is unavailable.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method for processing transactions, comprising:
initiating a transaction to access an account;
sending an authorization request to an authorization entity associated with the account;
sending itemization detail data associated with the transaction to the authorization entity; and
routing at least the itemization detail data to an owner of the account.

2. The method of claim 1, further comprising:
generating a transaction detail report including the itemization detail data and transaction summary data; and
sending the transaction detail report to the owner of the account.

3. The method of claim 1, wherein sending the itemization detail data further comprises sending the itemization detail data via at least one of a facsimile connection, a modem connection, a network connection, an email, and an Internet connection.

4. The method of claim 1, further comprising generating the transaction itemization detail data.

5. The method of claim 4, wherein generating the transaction itemization detail further comprises generating an image of a receipt associated with the transaction.

6. The method of claim 4, wherein generating the transaction itemization detail further comprises generating a text file including data related to items purchased in the transaction.

7. The method of claim 4, wherein generating the transaction itemization detail further comprises generating an image of a signature of an account user initiating the transaction.

8. The method of claim 1, wherein a plurality of users are authorized to access the account, and the method further comprises:
generating identification data associated with a selected one of the users initiating the transaction; and
sending the identification data to the owner of the account.

10. The method of claim 1, wherein sending the itemization detail data further comprises sending the itemization detail data responsive to the authorization entity approving the authorization request.

11. The method of claim 1, wherein sending the itemization detail data further comprises sending the itemization detail data coincident with the authorization request.

12. A method, comprising:
processing a transaction for accessing an account at a first location;
generating transaction detail data associated with the transaction; and
communicating the transaction detail data to an owner of the account remote from the first location.

13. The method of claim 12, wherein communicating the itemization detail data further comprises sending the itemization detail data via at least one of a facsimile connection, a modem connection, a network connection, an email, and an Internet connection.

14. The method of claim 12, wherein generating the transaction itemization detail, further comprises generating at least one of an image of a receipt associated with the transaction, a text file including data related to items purchased in the transaction, and an image of a signature of an account user initiating the transaction.

15. A system for processing transactions comprising:
a vendor entity adapted to initiate a transaction to access an account, generate an authorization request, and generate itemization detail data associated with the transaction; and
an authorization entity associated with the account and adapted to the receive authorization request, receive the itemization detail data from the vendor entity, and route at least the itemization detail data to an owner of the account.

16. The system of claim 15, wherein one of the vendor entity and the authorization entity is adapted to generate a transaction detail report including the itemization detail data and transaction summary data, and the authorization entity is adapted to sending the transaction detail report to the owner of the account.

17. The system of claim 15, wherein the authorization unit is adapted to send the itemization detail data to the owner via at least one of a facsimile connection, a modem connection, a network connection, an email, and an Internet connection.

18. The system of claim 15, wherein the vendor entity is further adapted to generate the transaction itemization detail data.

19. The system of claim 18, wherein the transaction itemization detail further comprises an image of a receipt associated with the transaction.

20. The system of claim 18, wherein the transaction itemization detail further comprises a text file including data related to items purchased in the transaction.

21. The system of claim 18, wherein the transaction itemization detail further comprises an image of a signature of an account user initiating the transaction.

22. The system of claim 15, wherein a plurality of users are authorized to access the account, and the transaction itemization detail comprises identification data associated with a selected one of the users initiating the transaction.

23. The system of claim 15, wherein the authorization entity is further adapted to approve the authorization request and the vendor entity is adapted to send the itemization detail data to the authorization entity responsive to the approval of the authorization request.

24. The system of claim 15, wherein the vendor entity is adapted to send the itemization detail data to the authorization entity coincident with the authorization request.

25. A system, comprising:
a communications network; and
a first entity configured to process a transaction for accessing an account at a first location, generate transaction detail data associated with the transaction; and communicate the transaction detail data over the communications network to an owner of the account remote from the first location.

26. The system of claim 25, wherein the first entity is adapted to communicate the transaction detail data to the owner over at least one of a facsimile connection, a modem connection, a network connection, an email, and an Internet connection.

27. The system of claim 25, wherein the transaction itemization detail includes at least one of an image of a receipt associated with the transaction, a text file including data related to items purchased in the transaction, and an image of a signature of an account user initiating the transaction.

28. A system, for processing transactions, comprising:
means for initiating a transaction to access an account;
means for sending an authorization request to an authorization entity associated with the account;
means for sending itemization detail data associated with the transaction to the authorization entity; and
means for routing at least the itemization detail data to an owner of the account.

29. A system, comprising:
means for processing a transaction for accessing an account at a first location;
means for generating transaction detail data associated with the transaction; and
means for communicating the transaction detail data to an owner of the account remote from the first location.
